(19) United States
(12) Patent Application Publication
(10) Pub. No.: US 2002/0067425 A1
(43) Pub. Date: Jun. 6, 2002

(54) Sealed digital camera system

(75) Inventor: Vaughn S. Iverson, Beaverton, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 09/731,522

(22) Filed: Dec. 6, 2000

(51) Int. Cl. H04N 5/232

(52) U.S. Cl. 348/373; 348/211; 348/372

(57) ABSTRACT

Embodiments of the invention provide a sealed digital camera system that eliminates the use of wear items in the case, essentially providing a fully-sealed digital camera system. As a result, the camera is protected from exposure to the outside environment during use and the integrity of the case is not degraded during normal operation. Unlike conventional systems, the sealed digital camera system of the present invention is not subject to catastrophic failure, even when used under high pressure for extended periods. Use of a high capacity integrated or replaceable storage system and/or battery system with the present invention eliminates the need for a user to access the camera itself. Images taken by the camera can be sent to an external display unit via a suitable transmission link, again without the need to open the case. The present invention provides vast improvements in reliability, ruggedness, maintainability as well as price competitiveness as compared with conventional underwater cameras.

### FIELD

This invention relates generally to digital cameras, and in particular, the present invention relates to sealed digital camera systems.

### BACKGROUND

As the popularity of water sports, such as SCUBA diving, snorkeling, kayaking, sailing, and so forth, has expanded, so has the use of cameras in these relatively harsh environments. As a result, attempts have been made to provide suitable camera coverings to protect the delicate inner workings of a camera, particularly digital cameras, from water, salt, dirt, and so forth.

One-use non-digital cameras are available for underwater photography. However, these cameras are only water-resistant and can actually implode at depths below about six (6) meters (about 20 ft). Furthermore, use of this type of camera on a routine basis can become quite expensive. Additionally, the case must be broken apart in order to remove images from the camera.

Other types of cameras are reusable, however, and also have cases that provide the needed resistance to dusty or dirty conditions. Such enclosures or cases can also provide moisture resistance, such as from splashing or rain, but are not suitable for immersion. Other enclosures are specifically designed for immersion, although these are limited to depths above six meters. One example of this type of case is a multi-layered resealable plastic bag.

Current camera cases designed to withstand several atmospheres of pressure are much thicker and quite expensive. Such cases must be made from high impact plastics or non-corrosive metals, such as aluminum. However, since access to the inside of the camera is required in order to load and unload film and batteries, etc. it is necessary to provide openings, such as doors, within these cases. Special machining and hardware (e.g., hinges, latches, and so forth) is required to provide these openings, which can significantly increase the cost of manufacturing, particularly with respect to metal cases. Furthermore, closing these openings requires various types of seals, such as “o-ring”-type gaskets. However, such seals are wear items that are prone to catastrophic failure, which can lead to a sensitive camera being flooded with water, usually destroying the unit. In addition, the latches and hinges that are required to properly secure a door are also wear items that can fail mechanically or through user error (e.g., door not fully latched, accidental opening under water, and so forth).

For the reasons stated above, there is a need in the art for a more practical, reliable and economic means for protecting cameras in harsh environments.

### BRIEF DESCRIPTION OF THE DRAWINGS

FIG. 1 is a schematic illustration of a sealed digital camera system in one embodiment of the present invention.

FIG. 2 is a flow diagram of a method of using a sealed digital camera system in one embodiment of the present invention.

### DETAILED DESCRIPTION

A sealed digital camera system is disclosed. In the following detailed description, reference is made to the accompanying drawings which form a part hereof, and in which is shown by way of illustration specific embodiments in which the inventions may be practiced. In the drawings, like numerals describe substantially similar components throughout the several views. These embodiments are described in sufficient detail to enable those skilled in the art to practice the invention, and it is to be understood that other embodiments may be utilized and that mechanical, procedural, electrical and other changes may be made without departing from the spirit and scope of the present inventions. The following detailed description is, therefore, not to be taken in a limiting sense, and the scope of the present invention is defined only by the appended claims, along with the full scope of equivalents to which such claims are entitled.

Embodiments of the invention provide a sealed digital camera system that eliminates the use of wear items in the case, essentially providing a fully-sealed digital camera system. As a result, the camera is protected from exposure to the outside environment during use and the integrity of the case is not degraded during normal operation. Unlike conventional systems, the sealed digital camera system of the present invention is not subject to catastrophic failure, even when used under high pressure for extended periods.

As used herein, the term “flash memory” refers to a particular type of storage system for storing digital images inside a sealed digital camera system. Other storage systems that can be used include any type of mechanical or electrical device capable of storing information on a non-removable media, such as a hard disk drive, optical disk, and so forth. The term “flash” is also used herein to specifically refer to the action of an optional strobe light, which is a type of light source that can be used in conjunction with the camera system.

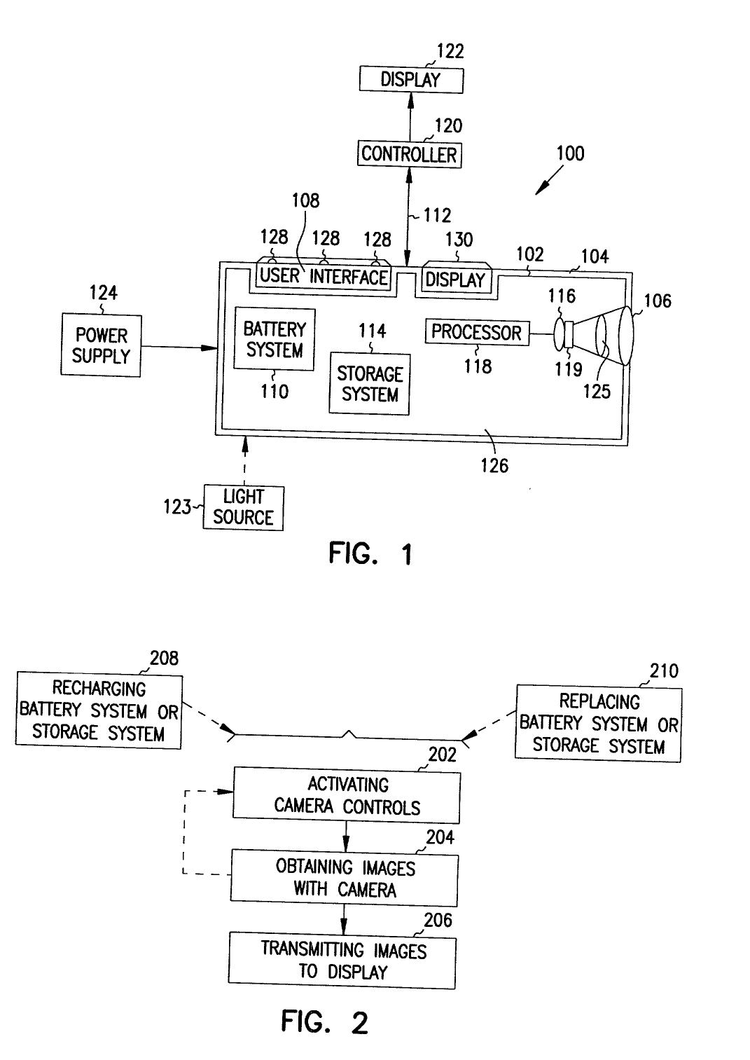

A sealed digital camera system 100 is shown in FIG. 1 comprising a camera 102 enclosed in a housing or case 104. In this embodiment, the camera has a lens 106, a user interface 108, a battery system 110, a transmission link 112, a storage system 114, an image sensor 116 connected to a processor 118, a shutter and iris 125, and an internal display 130. The camera 102 is in communication with a controller 120 and external display 122 via the transmission link 112. A power supply 124 provides power to the battery system 110 and can also provide power to the storage system 114. An optional light source 123 is in communication with the sealed digital camera system 100.

In one embodiment, the case 104 provides water resistance, as well as protection from contaminants such as dust, salt and other chemicals. The thickness of a water resistant case 104 can vary considerably, depending on the type of material, the type of camera, and so forth. However, since a water resistant case 104 is not designed to withstand high pressures, it is possible to use a relatively thin case in this embodiment. Furthermore, the thickness of a particular case 104 can vary, depending on the location. For example, corner areas or other areas of the case 104 that cover particularly fragile and/or protruding camera components may be reinforced and thus thicker than other portions of the case. In one embodiment, the reinforced areas are up to about 50% thicker. Any suitable material can be used, including metal, plastic, aluminum, and so forth. In one embodiment, a polypropylene case is used having a thickness in most locations of less than about 0.13 cm (about 0.05 in).

In another embodiment, the case 104 is waterproof, such that it can be immersed to depths of about six (6) meters (about 20 fit), while still maintaining its integrity. Again, the specific thickness of the case 104 is dependent on a number of factors. Furthermore, a given case can have varying thicknesses as noted above. Materials can again include metal, plastic, aluminum, and so forth. In one embodiment, a polycarbonate case is used having a thickness of less than about 0.3 cm (about 0.125 in).

In another embodiment, the case 104 is waterproof and pressure resistant, such that it maintains its integrity and provides protection for the camera 102 in water at depths below six (6) m, such as up to approximately 60 m (about 200 ft) or more. It is noted that recreational SCUBA (self-contained underwater breathing apparatus) diving certification agencies, such as PADI, have established uniform conventions for depth limits for nonprofessional divers. The maximum recommended limit for highly experienced recreational divers is about 40 m (about 130 ft), with a recommended limit of about 30 m (about 100 ft) in most situations. Novice divers are advised to remain above about 20 m (about 60 ft). The absolute maximum limit for recreational divers is widely considered by those in the art to be around 45 m (about 150 ft). At such depths, sea water exerts about five (5) atmospheres (atm) or approximately 75 psi on any enclosure that has a sealed airspace at surface pressure.

The camera 102 shown in FIG. 1 has internal air space 126. As such, the case 104 must be designed to withstand external pressures, such as those experienced underwater. In one embodiment, the camera system 100 has a working depth of approximately 60 meters, thus providing a margin of safety approximately 25% beyond the absolute maximum depth for recreational diving. In alternate embodiments, the camera system 100 is designed for the professional diver/photographer who may go below about 60 meters.

The total surface area of the case 104 can vary, depending on the size of the camera 102. In one embodiment, the case 104 has as much as about 0.6 m² (about 100 in²) of surface area. If it is assumed that there is approximately one (1) atmosphere (atm) (15 psi) of pressure for about every 11 meters (33 ft) of saltwater, at a depth of approximately 50 meters, a case 104 having about 0.6 m² (100 in²) of surface area needs to withstand pressure of about 3.3×10⁴ Newtons (N) (about 7500 lb_{f}), i.e., 75 psi×100 in², in all directions simultaneously. (The pressure for fresh water is comparable, within about three (3) percent). Therefore, it is important to provide a case 104 made from a suitable thickness of an appropriate material that can withstand the extreme pressures experienced underwater.

As noted above, any suitable type of material can be used, depending on the enduser's preferences and intended usage. This includes, but is not limited to, plastics, metals and so forth. In one embodiment, polycarbonate resin materials sold under the trademark LEXAN(® and having a thickness of about 0.3 cm to 0.64 cm (about 0.125 to 0.25 in), are used. Again, certain areas of the case may be reinforced by up to about 50% or more, although the invention is not so limited. Such a case 104 is likely suitable for a depth of up to about 60 meters, which is well in excess of the depths that recreational scuba divers will experience, thus providing a wide margin of safety. In another embodiment, an aluminum alloy housing is used with a thickness of less than about 0.3 cm (about 0.125 in). Such a case 104 may be suitable for depths up to about 90 meters.

In an alternative embodiment, the internal airspace 126 of the camera system 100 is filled with a suitable material, thus making it a solid unit that is substantially impervious to outside pressure. For example, non-optical spaces can be filled with a material such as plastic or resin. The “optical space” can be filled with any known optically-neutral material, such as a suitable liquid, solid (e.g., plastic, glass), gel, and so forth. The “optical space” is considered to be the space between the lens 106 and the image sensor 116. In embodiments having more than one lens 106, the “optical space” is considered to be the space between the image sensor 116 and the outermost lens 106. In such an embodiment, the camera's optics (i.e., light-sensing components) are designed to take this material into account, in order to avoid altering the image acquired with the camera system 100. A design in which the internal airspace 126 is filled as described is most practical for fixed-focus lens systems, as compared with zoom and auto-focus systems, which need to move optical elements, such as a zoom lens, within the optical space.

The case 104 can be combined with the camera 102 using any suitable manufacturing methods that will not harm the sensitive inner workings of the camera 102. In one embodiment, the case 104 is provided as one continuous piece or sheet of material surrounding the camera 102. In another embodiment, the case 104 is a “shell” that is molded in two separate parts to fit around the outer circumference of the camera 102, which is then placed in between the two parts. The two parts can be of equal size, although the invention is not so limited. The case 104 can then be permanently “sealed” or welded by any suitable means, such as by gluing, heating, e.g., ultrasonic bonding, and so forth. In one embodiment, closure is achieved through mechanical means, e.g., permanently installed screws and/or seals, and so forth. Such fixtures require no maintenance as they do not experience wear, unlike the seals, special hardware, and so forth, found on openings of conventional cases for sealed cameras.

In an alternative embodiment, the case 104 is designed to be removable. In one embodiment, the mechanical closures remain in place during normal operation, but are designed to be removed by an authorized repair technician. Such an arrangement has the advantage of allowing servicing on higher end cameras 102, yet the case 104 is not subject to wear via repeated opening and closing as with conventional underwater cameras. As a result, the camera 102 inside is not exposed to contamination from external sources during use. In another embodiment, the case 104 has a seam or indentation designed to be used in conjunction with a specifically-shaped tool to effect removal of the case 104. Again, in such an embodiment, it may be that a consumer returns the camera system 100 to the manufacturer or service center for repair. However, in most instances, the camera system 100 is designed to work for a suitable length of time, such that the consumer replaces the entire unit when it wears out.

The lens 106 can be any conventional type of lens (or set of lenses) 106 known in the art, providing it is designed to be waterproof, water resistant and/or pressure resistant, depending on the desired application. In one embodiment, the lens 106 is an image-receiving lens, from which the image sensor 116 itself detects images. In the embodiment shown in FIG. 1, the lens 106 is within the case 104, although the invention is not so limited. In another embodiment, the case 104 only partially surrounds the lens 106. In an alternative embodiment, a separate case made from the same type of material as the case 104 surrounding the camera 102 is used around the lens 106. Any suitable type of lens cap (not shown) can also be used with the camera system 100 for the outermost lens 106. As shown in FIG. 1, the lens 106 also contains a suitable shutter and iris 125 as is known in the art.

Any suitable type of image sensor 116 can be used. In one embodiment the image sensor 116 is a charge-coupled device (CCD) sensor that utilizes metal-oxide-semiconductor technology, surface storage and information transfer. In another embodiment, a complementary metal oxide semiconductor (CMOS) sensor is used. In the embodiment shown in FIG. 1, the image sensor 116 is bonded or sealed to a glass plate 119, although the invention is not so limited. However, the glass plate 119 provides structural stability to the image sensor 116, acting as a type of shock absorber. In conventional cameras, a glass plate also helps to protect a sensor from contamination. However, as noted above, the design of the camera system 100 itself provides adequate protection in this regard.

As shown in FIG. 1, the image sensor 116 is in communication with the processor 118, which can be any processor 118 known in the art designed for use with digital technology. In one embodiment, the processor 118 is a general purpose programmable processor, (e.g., an Intel Architecture Processor made by the Intel Corporation, Hillsboro, Oregon). In another embodiment, the processor 118 is any suitable type of digital signal processor (DSP). In yet another embodiment, the processor 118 is any type of specialized custom circuitry, i.e., Application Specific Integrated Circuit (ASIC).

The user interface 108 comprises the physical sealed buttons 128 that operate the camera, controlling mechanical functions such as the focus system, shutter, zoom lens, and so forth. Although the amount of light entering the camera system 100 (i.e.,f-stop settings) is typically controlled automatically in digital cameras, in one embodiment, these settings are also adjustable through the user interface 108. The user interface 128, via the various buttons and/or dials, switches, and so forth, also allows access to advanced on-screen controls that are displayed on the internal display 130, such as display mode settings, image composing and management, and other information, such as the status of various components (e.g., remaining battery life, remaining storage system life, and so forth). (In another embodiment, the internal display 130 provides status information continuously, without the need for the user to access the user interface 108, although in some embodiments, the status information can be turned off via the user interface 108, if desired). In one embodiment, the user interface 108 is implemented as sealed electronic buttons with no movable parts, similar to the type used on kitchen appliances, such as microwave ovens. In the embodiment shown in FIG. 1, the buttons 128 are designed to be an integrated part of the camera 102. In another embodiment, touch-screen technology, such as that used by pen-enabled PDA devices, can be employed instead of, or in addition to, button-type controls.

In another embodiment, the controls are all contained in a separate sealed user interface 108 that communicates with the camera 102 via any suitable type of transmission link, such as a radio frequency (RF) or infrared (IR) link or even a suitable wired link, such as is described below with respect to the transmission link 112. In one embodiment, the separate user interface 108 unit is detachable, thus allowing for remote control of the camera 102. A detachable configuration is particularly useful for underwater use. In this way, if the user interface 108 is lost or damaged, the replacement cost is limited to the unit itself and not the entire camera system 100.

In a detachable embodiment, the two components are operatively connectable to each other by suitable connector ports (not shown). In one embodiment, the connector ports are blind mate connector ports allowing the two components to “snap” together. Essentially, when the user interface 108 and camera 102 are assembled together, the blind mate connectors of the two components mate with one another to connect the components together operatively. No cabling, cords, or guide pins are necessary in this embodiment to connect the components together. In another embodiment, non-corrosive guide pins are used to connect the components together.

Power is supplied to the camera 102 with the battery system 110. The battery system 110 can be an integrated battery pack, which can be comprised of a single unit or a plurality of separate batteries. The battery system 110 can be rechargeable or designed to last for at least one or more day's use of the camera system 100. In one embodiment, the battery system 110 includes an inductive charging circuit which is placed in communication with the power supply 124, such as an inductive charging stand. In this way, power is provided to the camera 102 by induction, without the need for any direct contact between components. This system eliminates the need for a socket with exposed metal contacts. In an alternate embodiment, non-corrosive electrical contacts on the camera 102 are placed in direct contact with a suitable power source.

In one embodiment, the battery system 110 comprises a high capacity battery pack that can undergo a relatively large number of charging cycles. In one embodiment, the batteries can maintain a charge for at least one day up to two to three days or more. The number of charging cycles can be at least about or in excess of the expected life of the camera 102 itself, such as about 1,000 to 3,000 charging cycles or about three (3) to five (5) years. In an alternative embodiment, the batteries are charged using solar energy. In such an embodiment, the camera 102 can also includes an integrated solar panel. In a particular embodiment, a solar panel also comprises a folding inductive charging stand to enable recharging of the camera's batteries in sunny, remote locations.

In yet another embodiment, the battery system 110 is external to the camera 102 and is designed to connect to the camera 102 in any suitable way, such as by “snapping on,” as described above with the user interface 108. In this embodiment, the battery system 110 is fully sealed by a case of suitable thickness and material. Such an external battery system 110 can communicate with the camera system 100 by any suitable means. In embodiments where the battery system 110 itself is inductively charged, the same circuit can be used in reverse to inductively power the camera 102 when the battery system 110 is in place. In another embodiment, non-corrosive metal contacts on the sealed battery system 110 are provided. In both embodiments, a user can carry additional battery systems 110, and replace with a new system, i.e., battery pack, rather than charging a used one. The ability to replace the battery system 110 underwater provides an added convenience for underwater photographers. In one embodiment, the battery system 110 also communicates “status” to the camera system 100, i.e., level of charge remaining in the battery system 110. The status can be displayed on a “read-out” contained on the internal display 130 and/or on the battery system 110.

The storage system 114 is comprised of components that provide adequate storage capability for the camera 102. In one embodiment, the storage system 114 is a high capacity integrated flash memory unit that can provide at least a “day's worth” of storage, such as between about 30 to several hundred or more images. The storage system 114 can then be recharged with a suitable external power supply 124, or replaced, as desired, thus providing added convenience and options as noted above. The power supply 124 can be the same system that is used to recharge the battery system 110. In another embodiment, less than 30 images can be stored at one time in the storage system 114.

In another embodiment, interchangeable external storage units are used as the storage system 114. The storage units can be wireless, self-powered units that are separately sealed and require no electrical connection with the camera. For example, the units can be “snapped” into place in a manner similar to the aforementioned external components, and communicate with the camera via a suitable flash transmission link, such as a radio frequency (RF) or infrared (IR) link. In this way, the storage system 114 can be upgraded or replaced without the need to replace the entire camera system 100. Such an arrangement also significantly reduces the initial cost of the camera system 100 itself, and provides the user with a wide choice of storage systems 114 from which to select, even after purchasing the camera system 100. In an alternative embodiment, the storage system 114 is still interchangeable, but the camera 102 and storage system 114 communicate via non-corrosive external contacts provided on both components, i.e., a set of non-corrosive contacts as is known in the art. In yet another embodiment, there is a wired connection between the storage system 114 and the camera 104 that is similar to the transmission link 112 described below.

In yet another embodiment, the battery system 110 and storage system 114 are combined into one unit. Such a unit can be an integrated or interchangeable, as desired. The capacity of the combined unit can be proportional to accommodate typical use. The combined integrated unit can also be designed to be recharged or replaced as described above.

In some instances, additional lighting beyond what is available naturally may be needed. For example, underwater photography typically requires powerful strobes to illuminate subjects from different angles. In the embodiment shown in FIG. 1, an external light source 123 is optionally connected to the camera system 100 by any suitable connecting or transmission means as described herein (wired, wireless, non-corrosive contacts, and so forth). Additionally, communication between the external light source 123 and camera system 100 must be synchronized so that the external light source 123 fires at the appropriate time with respect to the operation of the shutter 125. The external light source 123 can be a strobe light, i.e., illumination unit, having its own power source that is interchangeable underwater, such as an inductive battery pack. Such an external light source 123 has all of the advantages as described above for the interchangeable storage system 114 and/or battery system 110. In one embodiment, the light source is an inductively rechargeable external strobe light in communication with the camera system 100 via wired means, wireless means or non-corrosive contact means.

In an alternative embodiment, there is a light source contained within the camera system 100, i.e., internal light source, capable of providing at least a day's worth of light “flashes,” such as about 30 to several hundred flashes, before needing recharging. Again, such a light source can be a strobe light. Such an embodiment is more likely found in a waterproof or water resistant camera system.

The camera 102 further has means for outputting an image obtained through use to an outside source, such as the controller 120, without opening the case 104. In one embodiment, the transmission link 112 provides the means to output such images to the controller 120, which in turn send the image to the external display 122 for viewing. Unlike conventional cameras, this can all be accomplished without holes or openings in the case 104 or exposed metal electrical contacts. The transmission link 112 can be any suitable type of wired or wireless medium using any suitable bandwidth over which information can be transmitted. Preferably, the link is sufficiently fast to allow for convenient access to a large number of high quality images in a reasonable amount of time. This includes, but is not limited to a parallel connection, a serial connection, thin or thick coaxial cable, twisted-pair wiring, copper wiring, a fiber-optic cable, including electro-optical fibers and integrated-optical fibers, a wireless connection using transmissions such as infrared or RF and so forth. In another embodiment, a “Bluetooth Standard” RF link is used.

The transmission link 112 can send and receive signals over any type of network operatively connected to the controller 120, including alternating current (AC) wiring, telephone wiring or conventional cable TV wiring. In another embodiment, the network is a local area network (LAN), such as Ethernet, Asynchronous Transfer Mode (ATM), ring, token ring, star, bus, and so forth. In one embodiment, the transmission link 112 comprises a two-way whole structure Ethernet connection using standard protocol, such as Transmission Control Protocol/Internet Protocol (TCP/IP) having a bandwidth of about 10,000 kilobits per second. Use of a high speed LAN, such as an Ethernet network provides for high primary speed, thus allowing for fast downloading of images from the digital camera system 100 to the controller 120.

In one embodiment an Infrared Data Association (IrDA)-type of infrared connection is used as the transmission link 112. IrDA ports support roughly the same transmission rates as traditional parallel ports. However, with this type of link, it is important that the two devices be within a few meters of each other. Furthermore, there must be a clear line of sight between them. In another embodiment, non-corrosive external contacts are used to provide a link. In one embodiment, a suitable wired link is used, similar to the wired links used in submersible decompression computers for divers.

With any type of transmission link 112, it is possible to transfer the output of the camera system 100, i.e., images, to the controller 120. The controller 120 may be a local or remote receiver only, or a computer, such as a lap top general purpose computer or a specially-designed Application Specific Integrated Circuit (ASIC)-based controller as is well-known in the art. In one embodiment, the controller 120 is a personal computer having all necessary components for processing the input signals and generating appropriate output signals as is understood in the art. These components can include a processor, a utility, a driver, an event queue, an application, and so forth, although the invention is not so limited. In one embodiment, these components are all computer programs executed by a processor of the computer, which operates under the control of computer instructions, typically stored in a computer-readable medium such as a memory. In this way, useful operations on data and other input signals can be provided by the computer's processor. The controller 120 also desirably includes an operating system for running the computer programs, as can be appreciated by those within the art. The controller 120 further includes a separate controller user interface (not shown) as is known in the art. Such a controller user interface can be any type of suitable communication device or transceiver, including, but not limited to, any type of telephone, key pad, keyboard, and so forth. The images received by the controller 120 from the camera system 100 can be viewed on any suitable display. Images can also be printed using a suitable printing device and paper, transmitted to other computers or controllers, and so forth, as is known in the art. In another embodiment, the controller 120 is a printer.

There exist a number of other interfaces, buses or other communication devices between the various components described herein, such as between the power supply 124 and the battery system 110, the hand controls 108 and the camera 104, and so forth. Such interfaces comprise all necessary conventional electrical and mechanical components as is understood in the art, and will not be discussed in detail herein.

The camera system 100 as described herein can be used with virtually any type of digital camera, including digital video cameras, with appropriate modifications. For example, the storage system 114 in a video camera is necessarily designed to accommodate extremely large amounts of data storage, as compared with a still camera. In one embodiment, a high capacity hard disk or optical disk is used for image storage. The image sensor 116 in a video camera is necessarily designed to produce several images per second, although the images can have a lower resolution as compared with a still digital camera. The lens system 106 is typically designed differently in a video camera as compared with a still camera, because of the need to continually auto-focus. There is no requirement for a conventional shutter 125 in a video digital camera, as there is an alternative mechanism that continuously scans the image sensor 116, as is known in the art. Other differences include the requirements for a microphone and audio processing, as well as the need for continuous illumination. In some embodiments, the external display 122 can be a monitor or television screen broadcasting recorded images or images occurring in real-time. The size and shape of the case 104 is necessarily designed to accommodate various sizes and shapes of video cameras.

As shown in FIG. 2, the present invention further includes a method for using a sealed digital camera system. The method comprises activating 202 internal camera controls with a user interface, obtaining 204 one or more images with the camera system, and transmitting 206 the one or more images to a display with a transmission link in communication with the camera system. Additional images can repeatedly be obtained 204 by activating 202 the appropriate camera controls.

In one embodiment, the method can further comprise recharging 208 a battery system and/or a storage system with an external power supply, such as an inductive charging mechanism. In another embodiment, the method can further comprise replacing 210 the storage system or battery system, as described above. In yet another embodiment, not shown in FIG. 2, the method can comprise recharging an external strobe/illumination unit with an external power supply or replacing the external strobe/illumination unit, as discussed above.

Digital photography is a powerful emerging market that has the potential to rapidly displace traditional film-based photography in many or most uses. This, in combination with the fast growing recreational segment of water sports, creates a sizeable market for improved outdoor and underwater photography. The present invention provides vast improvements in reliability, ruggedness, maintainability as well as price competitiveness as compared with conventional underwater cameras. By providing a camera that has either high capacity integrated components or fully interchangeable components together with a fully sealed housing, there is now no need to access the interior of the camera during use, thus eliminating the need for openings, such as hinged doors or coverings that may require o-rings or other mechanical connecting means. The present invention is simpler and less expensive to design and manufacture. Further, because the camera is never open to the environment, even momentarily, the chance for contaminates being inadvertently introduced is essentially nonexistent.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is manifestly intended that this invention be limited only by the claims and the equivalents thereof.

What is claimed:

1. A digital camera system, comprising:
a digital camera having an image-receiving lens and an image sensor, the image sensor designed to detect an image from the lens; and
a sealed case surrounding the digital camera, the case constructed and arranged for providing a water resistant enclosure for the camera and adapted for transmission of the image from the image sensor to a display located external to the case without opening the case.

2. The camera system as recited in claim 1 wherein the case is formed from two sections of material permanently bonded together.

3. The camera system as recited in claim 1 wherein the case is waterproof at depths less than about six meters.

4. The camera system as recited in claim 1 wherein the case is pressure resistant at depths up to about 60 meters.

5. The camera system as recited in claim 4 wherein the case is made from a polycarbonate resin material, further wherein areas of the case are reinforced.

6. The camera system as recited in claim 1 wherein the case is pressure resistant at depths up to about 90 meters.

7. The camera system as recited in claim 6 wherein the case made from an aluminum alloy.

8. The camera system as recited in claim 1 wherein non-optical internal airspace within the case is filled with a solid or liquid material.

9. The camera system as recited in claim 8 wherein internal airspace between the lens and an image sensor is filled with an optically-neutral material.

10. The camera system as recited in claim 1 further comprising:
a battery system;
a storage system powered by the battery system;
a user interface in communication with the storage system and battery system;
an internal display in communication with the user interface; and
an image transmitting apparatus for outputting an image from the camera to a controller external to the case.

11. The camera system as recited in claim 10 wherein the means for outputting the image comprises a wired or wireless transmission link.

12. The camera system as recited in claim 11 wherein the wireless link is an infrared link or radio frequency link.

13. The camera system as recited in claim 10 wherein the storage system is a high-capacity integrated storage system.

14. The camera system as recited in claim 13 wherein the storage system is rechargeable with an inductive charging mechanism.

15. The camera system as recited in claim 10 wherein the storage system is interchangeable.

16. The camera system as recited in claim 10 wherein the battery system is a high-capacity integrated battery system.

17. The camera system as recited in claim 16 wherein the battery system is rechargeable with an inductive charging mechanism.

18. The camera system as recited in claim 17 wherein the battery system is rechargeable using solar energy.

19. The camera system as recited in claim 10 wherein the battery system is interchangeable.

20. The camera system as recited in claim 10 wherein the battery system and storage system are combined into a single unit located in a sealed case external to the camera case.

21. The camera system as recited in claim 17 further comprising a light source in communication with the camera system.

22. The camera system as recited in claim 21 wherein the light source is an inductively rechargeable external strobe light in communication with the camera system via a wired link, wireless link or a set of non-corrosive contacts.

23. A camera system designed for underwater use comprising:
a digital camera;
a sealed case surrounding the digital camera; and
a transmission link for outputting images from the digital camera to a remote controller.

24. The camera system as recited in claim 23 wherein the digital camera is a video camera.

25. The camera system as recited in claim 23 wherein the remote controller is a personal computer.

26. The camera system as recited in claim 23 wherein the remote controller is a printer.

27. The camera system as recited in claim 23 wherein the transmission link is a wired link or a wireless link.

28. A method for using a sealed digital camera system comprising:
activating internal camera controls with a user interface;
obtaining one or more images with the camera system; and
transmitting the one or more images to a controller with a transmission link in communication with the camera system.

29. The method of claim 28 further comprising recharging a battery system using an external power supply.

30. The method of claim 29 wherein the power supply is an inductive charging mechanism.

31. The method of claim 28 further comprising recharging a storage system using an external power supply, the storage system in communication with the camera system.

32. The method of claim 31 wherein the power supply is an inductive charging mechanism.

33. The method of claim 28 further comprising replacing an external storage system contained in a sealed case, the external storage system designed to communicate image data with the camera system during use.

34. The method of claim 28 further comprising replacing an external battery system contained in a sealed case, the external battery system designed to communicate with the camera system during use.

35. The method of claim 34 wherein the battery system communicates power and charge status to the camera system.

36. The method of claim 28 comprising replacing or recharging a combination battery and storage system.

37. The method of claim 28 further comprising illuminating an area with a light source which is in communication with the camera system.

38. The method of claim 28 further comprising viewing information on an internal display in communication with the user interface and located in the camera system.
